(19) United States
(12) Patent Application Publication
(10) Pub. No.: US 2012/0074633 A1
(43) Pub. Date: Mar. 29, 2012

(54) Centering and Clamping Device

(75) Inventor: Walter Fleischer, Frankfurt (DE)

(73) Assignee: Delaware Capital Formation, Inc., Wilmington, DE (US)

(21) Appl. No.: 13/235,610

(22) Filed: Sep. 19, 2011

(30) Foreign Application Priority Data
Sep. 23, 2010 (DE) 102010046190.3

(51) Int. Cl. B23Q 1/00

(52) U.S. Cl. 269/47

(57) ABSTRACT

A centering and clamping device has a movable clamping hook (2) situated on a housing (1). The clamping hook (2) extends through a housing wall so that it is operably connected with a drive mechanism inside the housing (1). The clamping hook (2) executes a lifting and pivoting movement. The drive mechanism has a lever element (3) operationally linked to the clamping hook (2). The lever element (3) is rotatably mounted around an axis element (4) situated in the housing (1). The axis element (4) of the lever element (3) is mounted on the housing so that it is elastically movable in the housing (1) in a lifting direction.

### CROSS-REFERENCE TO RELATED APPLICATION

This application claims priority to German Application No. DE102010046190.3, filed Sep. 23, 2010. The disclosure of the above application is incorporated herein by reference.

### FIELD

The disclosure relates to a centering and clamping device and, more particularly, to a movable clamping hook extending through a housing wall connected with a drive mechanism executing a lifting and pivoting movement with an axis element of a lever element mounted on the housing so that it is elastically movable in a housing in the lift direction.

### BACKGROUND

A centering and clamping device is known according to DE 102 38 815 B3. It includes a movable clamping hook situated on a housing. The clamping hook extends through a housing wall so that it is operable with a drive mechanism inside the housing. The clamping hook executes lifting and pivoting movements. The drive mechanism has a lever element. The lever element is operationally linked to the clamping hook. The clamping hook is mounted so that it is rotatable around an axis situated transversely to the lift direction in the housing. The clamping hook (depending on the clamping position) is at least partially mounted inside a centering mandrel, also situated on the housing. The centering and clamping device is used to clamp (or brace) components provided with an opening matching the centering mandrel for further processing purposes against a corresponding counter bearing provided on the housing. In order to be able to clamp various component thicknesses, the counter bearing is adjustable to the housing. The procedure of configuring to the corresponding component thickness is also referred to in technical circles as “shimming”.

### SUMMARY

The disclosure is based on the object of improving a centering and clamping device of the mentioned type, in particular under the aspect of a component thickness compensation, that functions as simply as possible.

The object is achieved by a centering and clamping device comprising a movable clamping hook situated on a housing. The clamping hook extends through a housing wall so that it is operably connected with a drive mechanism inside the housing. The clamping hook executes a lifting and pivoting movement. The drive mechanism has a lever element operationally linked to the clamping hook. The lever element is rotatably mounted around an axis element situated in the housing. The axis element of the lever element is mounted on the housing so that it is elastically movable in the housing in a lifting direction.

According to the disclosure, the axis of the lever element is mounted so that it is elastically movable in the housing in the lift direction.

In other words, according to the disclosure, the axis is no longer completely immobile (rigid), but rather is elastically mounted in the housing in at least one direction, namely in the direction of the clamp or lift movement. This elasticity has the result that smaller component thickness differences are readily acceptable even without reconfiguring the counter bearing. Thus, within a certain tolerance range, the “shimming” can be completely dispensed with according to the disclosure. Thus, if necessary, the axis of the lever element simply yields, accordingly, in the lift direction, in the direction of the clamping hook.

Other advantageous refinements of the centering and clamping device according to the disclosure will become apparent to those skilled in the art.

The centering and clamping device, including the advantageous refinements, is explained in greater detail hereafter on the basis of the illustration in the drawings of a preferred exemplary embodiment.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side cross-sectional view of the centering and clamping device in the clamping position, without a workpiece.

FIG. 2 is a view like FIG. 1 of the centering and clamping device in the open position.

FIG. 3 is a perspective view of a housing shell of the centering and clamping device without a drive mechanism, but with the axis element mounted so that it is elastically movable.

FIG. 4 is a perspective view of the centering and clamping device according to FIG. 1 with a closed housing.

FIG. 5 is a cross-sectional view of FIG. 3 along line 5-5 thereof.

### DETAILED DESCRIPTION

The centering and clamping device shown in the figures includes a movable clamping hook 2 situated on a housing 1. The clamping hook 2 extends through a housing wall so that it is operably connected with a drive mechanism inside the housing 1. The clamping hook 2 executes a lifting and pivoting movement. The drive mechanism has a lever element 3 that is operationally linked to the clamping hook 2. The lever element 3 is mounted so that it is rotatable around an axis element 4 situated in the housing 1. Furthermore, the externally cuboid housing 1 is formed from two aluminum half-shells 5, 6 that receive the drive mechanism between them. The axis element 4 is situated between the two half-shells 5, 6 of the housing 1. The axis element 4 is perpendicular to the housing 1 and runs transversely to the lift direction.

The drive mechanism includes a drive element 14 with a linearly movable positioning rod 15, the lever element 3, and a drag element 16. The drag element 16 is articulated on one side with the clamping hook 2 and on the other side with the lever element 3. The drive element 14, for example, a pneumatic or hydraulic cylinder or an electric drive, is situated on the end of the housing 1 facing away from the clamping hook. The lever element 3 has two lever arms 17, 18 that are angled with respect to one another. The lever element 3 and the positioning rod 15 are articulated with one another, via a slot guide 19. A through borehole 20 receives the bolt-shaped axis element 4. The axis element 4 is implemented as a cylindrical component and is provided on the lever element 3.

Furthermore, the clamping hook 2 passes through a sealed opening 21 on the housing 1. A centering mandrel 22 is externally situated on the housing 1 at the opening 21. The centering mandrel 22 has a receptacle area 23 (see FIG. 4) for the clamping hook 5. In addition, the centering mandrel 22 is positioned on an adapter plate 24, which is positioned on the housing 1.

With respect to the illustrated embodiment of the guide of the clamping hook 2 in the sealed opening 21, which differs from the solution according to DE 102 38 815 B3, reference is otherwise made to DE 10 2010 044 327 A1, which was later published.

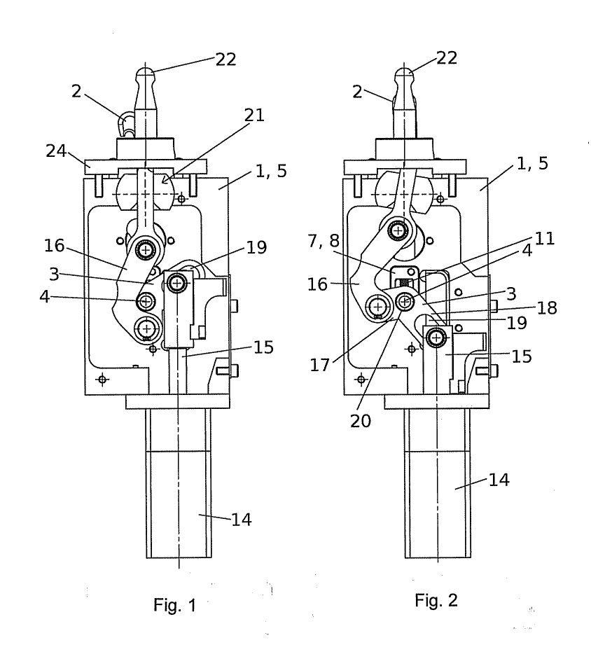

It is essential for the centering and clamping device that the axis element 4 of the lever element 3 is elastically movable or mounted so that it is displaceable in the housing 1 in the lift direction. As seen in FIG. 1, due to this measure, the clamping hook 2 has a certain mobility in the lift direction in the scope of the elasticity of the mounting of the axis element 4. The elasticity of the axis 4 is sufficient to compensate for smaller variations in the component thickness.

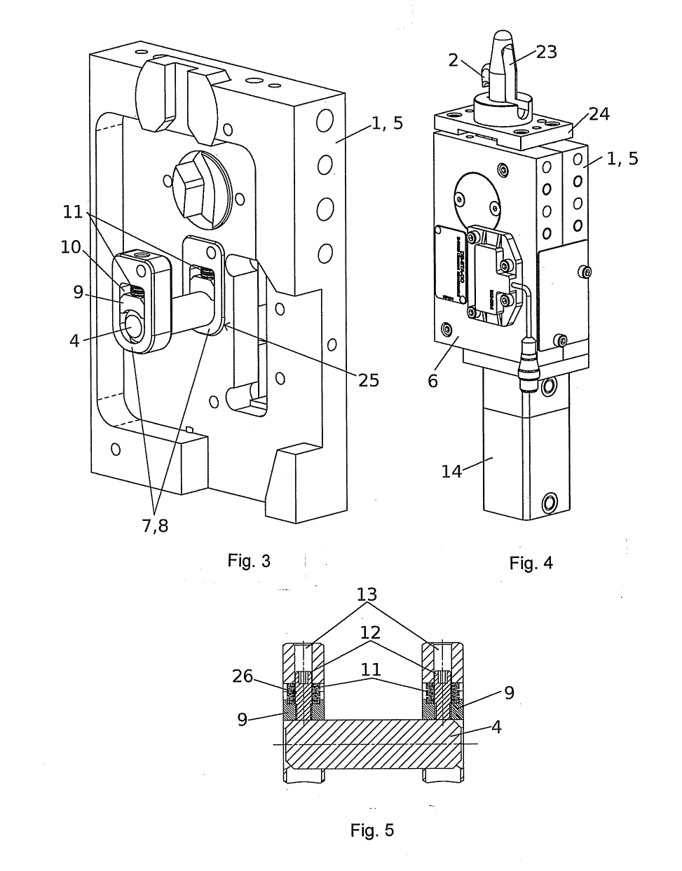

As best seen in FIGS. 3 and 5, a receptacle elements 7 receives the axis element 4 and mounts it in an elastically movable manner on each half-shell 5, 6. The receptacle elements 7 include a frame 8, preferably formed from steel, and a counter bearing 9, also made of steel. The axis element 4 is mounted so that it is elastically movable in the receptacle elements 7. The frame 8 has a slotted, axis-width receptacle slot 10 for the axis element 4. A spring element 11 is positioned between a wall of the receptacle slot 10 and the counter bearing 9. The spring element 11 is formed from at least one plate spring and is thus quite stiff. The counter bearing 9 is as wide as the axis element 4 and is mounted so that it is movable or displaceable in the lift direction in the receptacle slot 10. In addition, a recess 25 matching precisely with the receptacle elements 7 is provided in each half-shell 5, 6. Thus, the axis element 4 is easily replaceable together with the receptacle elements 7, as a module. Alternatively, if needed, a corresponding inelastic element without a movable axis element may be substituted.

A cylindrical guide element 12, similar to a grub screw, is positioned between the frame 8 and the counter bearing 9. The guide element 12 is positioned to run at least partially in a through borehole 13 of the frame 8. This guide element 12 ensures that the plate spring provided with a through borehole 26, penetrated by the guide element 12, cannot fall out of the receptacle element 7. Thus, it simultaneously forms a further guide for the counter bearing 9. Additionally, the counter bearing 9 is screwed together with the guide element 12.

The present disclosure has been described with reference to a preferred embodiment. Obviously, modifications and alternations will occur to those of ordinary skill in the art upon reading and understanding the preceding detailed description. It is intended that the present disclosure be construed to include all such alternations and modifications insofar as they come within the scope of the appended claims or their equivalents.

What is claimed is:

1. A centering and clamping device comprising:
a movable clamping hook situated on a housing, the clamping hook extends through a housing wall so that it is operably connected with a drive mechanism inside the housing, the clamping hook executes a lifting and pivoting movement;
the drive mechanism includes a lever element, the lever element is operationally linked to the clamping hook, the lever is mounted so that it is rotatable around an axis element situated in the housing; and
the axis element of the lever element is mounted on the housing so that it is elastically movable in the housing in the lift direction.

2. The centering and clamping device according to claim 1, wherein the housing is formed from two half-shells that receive the drive mechanism between them, and the axis is situated between the two half-shells of the housing, the axis is perpendicular to the housing and running transversely in the lift direction, a receptacle element for accommodating and elastically movably mounting the axis situated on each half-shell.

3. The centering and clamping device according to claim 2, wherein the receptacle element includes a frame and a counter bearing, the axis element is elastically movably mounted in the receptacle element.

4. The centering and clamping device according to claim 3, wherein the frame has a slotted, axis element width receptacle slot for receiving the axis element.

5. The centering and clamping device according to claim 4, further comprising a spring element situated between a wall of the receptacle slot and the counter bearing.

6. The centering and clamping device according to claim 5, wherein the spring element is formed from at least one plate spring.

7. The centering and clamping device according to claim 4, wherein the counter bearing is as wide as the axis element and is mounted so that it is movable in the lift direction in the receptacle slot.

8. The centering and clamping device according to claim 3, further comprising a guide element positioned between the frame and the counter bearing.

9. The centering and clamping device according to claim 8, wherein the guide element is cylindrical.

10. The centering and clamping device according to claim 8, wherein the guide element is at least partially situated in a through borehole of the frame.
